(19) United States
(12) Patent Application Publication
(10) Pub. No.: US 2016/0163276 A1
(43) Pub. Date: Jun. 9, 2016

(54) GOA DISPLAY PANEL, DRIVING CIRCUIT STRUCTURE, AND DRIVING METHOD THEREOF

(71) Applicant: SHENZHEN CHINA STAR OPTOELECTRONICS TECHNOLOGY CO LTD., Shenzhen (CN)

(72) Inventor: Je Hao HSU, Shenzhen (CN)

(21) Appl. No.: 14/416,736

(22) PCT Filed: Dec. 24, 2014
(86) PCT No.: PCT/CN2014/094857

§ 371 Date: Jan. 23, 2015

(30) Foreign Application Priority Data
Dec. 8, 2014 (CN) 201410748472.5

(51) Int. Cl. G09G 3/36

(52) U.S. Cl. CPC G09G 3/3696; G09G 3/3674; G09G 3/3648; G09G 2300/0426; G09G 2310/0202; G09G 2310/0248; G09G 2310/08; G09G 2330/021; G09G 2320/0209

(57) ABSTRACT

The present disclosure discloses a GOA display panel, a driving circuit device, and a driving method thereof, said driving circuit device comprising a plurality of scanning lines, a fist control circuit, and a second control circuit. Two control circuits are added between a GOA circuit area and an active area, whereby a normal 2D display can be realized, and the dual-gates are turned on simultaneously during 3D display. In addition, the circuits can be realized only with the two empty pins of the source driving IC, which means no new additional design is necessary. Thus the cost thereof can be reduced.

### CROSS REFERENCE TO RELATED APPLICATION

The present application claims benefit of Chinese patent application CN 201410748472.5, entitled “GOA Display Panel, Driving Circuit Structure, and Driving Method Thereof” and filed on Dec. 8, 2014, which is incorporated herein by reference.

### FIELD OF THE INVENTION

The present disclosure relates to the technical field of liquid crystal display, and particularly to a GOA display panel, a driving circuit device, and a driving method thereof

### BACKGROUND OF THE INVENTION

The driving circuit of liquid crystal display device is mainly manufactured through providing Integrated Circuit (IC) which connects with the liquid crystal panel from the outside in the prior art. By contrast, in the Gate Driver on Array technology, also referred to as GOA technology for short, the Gate Driver ICs are manufactured directly on the array substrate, in order to replace the driving chip obtained by the external silicon chip. Since the GOA circuit can be directly manufactured around the panel, the manufacturing procedure thereof can be simplified. Moreover, the manufacturing cost thereof can be reduced, and the integration of the liquid crystal panel can be improved. Thus the thickness of the liquid crystal panel can be further reduced.

The mainstream three dimensional (3D) display technologies in the current market comprise anaglyphic 3D display technology, polarization 3D display technology, 3D shutter glass display technology, and naked eye 3D display technology. The 3D shutter glass display technology is widely accepted in the market thanks to its advantages of prominent three dimensional display effects, high resolution of the screen, and relatively low cost of the liquid crystal module.

However, due to the influence of the response speed of liquid crystal, the cross-talk phenomena would appear. For example, when the left eye is watching the left-eye image, it would watch the residual part of the right-eye image of the last frame, which would lead to the phenomenon of the left-eye image and the right-eye image overlapping with each other. In this case, the ghost image would appear. This kind of phenomenon exists in all shutter 3D televisions based on liquid crystal display technology. In order to reduce the cross-talk phenomena during 3D display, the scanning switching technology or the dynamic local dimming technology are usually used in the back-light unit.

Since the structure of the control circuit needed in the scanning switching technology and the dynamic local dimming technology is complex, and the cost thereof is relatively high, a solution that a black frame is inserted between left-eye signals and right-eye signals whereby the cross-talk phenomena thereof can be reduced is proposed. However, since the left eye and the right eye receive signals alternately in the shutter 3D technology, the requirement on the frame rate thereof is relatively high, which is 120 Hz in general. If the black frame insertion technology is adopted, the frame rate thereof should be doubled, which would have a large effect on the charging of the liquid crystal panel. Therefore, another solution through which the dual-gates are turned on simultaneously during 3D display, so as to reduce the resolution in the scanning direction and raise the charging time is proposed. However, new and complex designs should be added on the Printed Circuit Board (PCB) and the gate IC in order to realize the above functions.

Therefore, as to the GOA display panel, how to reduce the cross-talk phenomena in the shutter 3D display technology through black frame insertion technology, as well as reduce the influence of high frame rate on the charging of the liquid crystal panel without new complicated design being added therein has become an effort demanding task in the industry.

### SUMMARY OF THE INVENTION

One of the technical problems to be solved by the present disclosure is to provide a driving circuit device for GOA display panel, which can not only reduce the cross-talk phenomena in the shutter 3D display technology through black frame insertion technology, but also reduce the influence of high frame rate on the charging of the liquid crystal panel. In addition, the present disclosure further provides a GOA display panel and the driving method thereof.

1. In order to solve the aforesaid technical problem, the present disclosure provides a driving circuit device for GOA display panel, comprising: a plurality of scanning lines; a first control circuit, configured to control the on/off states of all odd-numbered scanning lines or all even-numbered scanning lines of said plurality of scanning lines; and a second control circuit, configured to realize different connection states in each pair of scanning lines, which consists of an odd-numbered scanning line and a corresponding even-numbered scanning line of said plurality of scanning lines under different display modes, said display modes comprising two dimensional display mode and three dimensional display mode, wherein the odd-numbered scanning line and the even-numbered scanning line of a pair of scanning lines are turned on simultaneously under three dimensional display mode.

2. In one preferred embodiment of item 1 of the present disclosure, said first control circuit and said second control circuit are both arranged between a GOA circuit area and an active area, and wherein said first control circuit comprises: a first specified number of switching transistors, each switching transistor being connected to a corresponding odd-numbered scanning line or a corresponding even-numbered scanning line of said plurality of scanning lines respectively; and a first control signal line, configured to control the on/off state of each switching transistor, said first control signal line being connected to the gate of each of said first specified number of switching transistors, and said second control circuit comprises: a second specified number of switching transistors, each switching transistor being connected between the odd-numbered scanning line and the even-numbered scanning line of a corresponding pair of scanning lines respectively; and a second control signal line, configured to control the on/off state of each switching transistor, said second control signal line being connected to the gate of each of said second specified number of switching transistors.

3. In one preferred embodiment of item 1 or item 2 of the present disclosure, the ends of said first control circuit and said second control circuit are arranged in two empty pins of a source driving chip respectively.

4. According to another aspect of the present disclosure, the present disclosure further provides a GOA display panel, comprising the aforesaid driving circuit device.

5. According to another aspect of the present disclosure, the present disclosure further provides a GOA liquid crystal display panel, said liquid crystal display panel comprising a plurality of scanning lines, and a first control circuit and a second control circuit both arranged between a GOA circuit area and an active area of said GOA liquid crystal display panel, said method comprising: during a display stage under different display modes, controlling, by said first control circuit, the on/off states of all odd-numbered scanning lines or all even-numbered scanning lines of said plurality of scanning lines; and realizing, by said second control circuit, different connection states in each pair of scanning lines, which consists of an odd-numbered scanning line and a corresponding even-numbered scanning line of said plurality of scanning lines, said display modes comprising two dimensional display mode and three dimensional display mode, wherein the odd-numbered scanning line and the even-numbered scanning line of a pair of scanning lines are turned on simultaneously under three dimensional display mode.

6. In one preferred embodiment of item 5 of the present disclosure, the method further comprises: during a display stage under two dimensional display mode, providing, by the first control signal line of said first control circuit, a turn-on voltage to each of the first specified number of switching transistors, so as to turn on all odd-numbered scanning lines or all even-numbered scanning lines, wherein the gate of each of said first specified number of switching transistors is connected to said first control signal line; providing, by the second control signal line of said second control circuit, a turn-off voltage to each of the second specified number of switching transistors, so as to turn off the connection between the odd-numbered scanning line and the even-numbered scanning line in each pair of scanning lines, wherein the gate of each of said second specified number of switching transistors is connected to said second control signal line; and controlling a progressive transmission of scanning signals of each scanning line of said plurality of scanning lines with precharge scanning mode.

7. In one preferred embodiment of item 5 or item 6 of the present disclosure, during a display stage under three dimensional display mode, providing, by said first control signal line, when all odd-numbered scanning lines or all even-numbered scanning lines of said scanning lines are turned on, a turn-off voltage to each of the first specified number of switching transistors, so as to turn off all odd-numbered scanning lines or all even-numbered scanning lines; providing, by said second control signal line, during the whole scanning cycle, a turn-on voltage to each of the second specified number of switching transistors, so as to realize short-circuit between the odd-numbered scanning line and the even-numbered scanning line in each pair of scanning lines; and controlling a progressive transmission of scanning signals of each scanning line of said plurality of scanning lines with precharge scanning mode.

8. In one preferred embodiment of item 5 to item 7 of the present disclosure, said precharge scanning mode is four-graded precharge scanning.

Compared with the prior art, one embodiment or a plurality of embodiments of the present disclosure may have the following advantages.

According to the present disclosure, two control circuits are added between a GOA circuit area and an active area, wherein one control circuit means adding a Thin Film Transistor (TFT) control switch to each of all odd-numbered scanning lines or all even-numbered scanning lines, and another control circuit means adding a TFT control switch between an odd-numbered scanning line and a corresponding even-numbered scanning line which together form a pair of scanning lines. By means of the two control circuits, a normal two dimensional (2D) display can be realized, and the dual-gates are turned on simultaneously through Shutter Glass (SG) black frame insertion technology (the frame rate thereof is 240 Hz) during 3D display. In addition, the circuits can be realized only with the two empty pins of the source driving IC, which means no new additional design is necessary. Thus the cost thereof can be reduced.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings are used to provide further understandings of the present disclosure and constitute one part of the description. The drawings are used for interpreting the present disclosure together with the embodiments, not for limiting the present disclosure. In the drawings:

FIG. 1 schematically shows an equivalent circuit of a driving circuit device of a display panel according to one embodiment of the present disclosure; and

FIG. 2 is a time-sequence diagram when a display panel comprising the driving circuit as shown in FIG. 1 is performing 2D display and 3D display.

### DETAILED DESCRIPTION OF THE EMBODIMENTS

The present disclosure will be illustrated in detail hereinafter in combination with the accompanying drawings to make the purpose, technical solutions, and advantages of the present disclosure more clear.

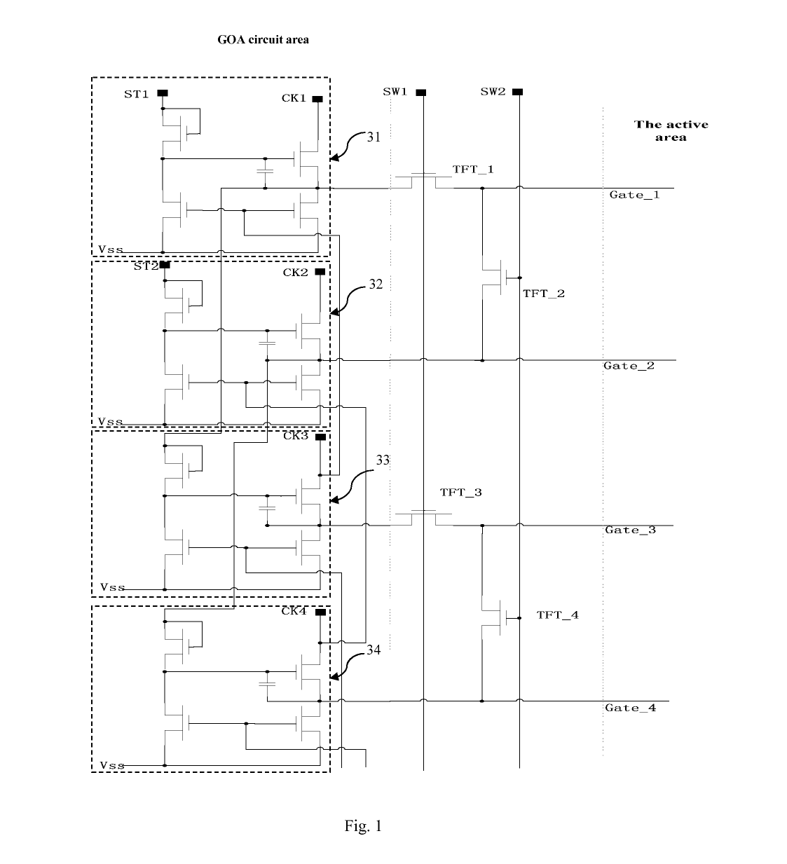

FIG. 1 schematically shows an equivalent circuit of a driving circuit device of a GOA display panel according to one embodiment of the present disclosure.

The driving circuit comprises a plurality of scanning lines, such as Gate 1, Gate_2, Gate_3, and Gate_4 as shown in FIG. 1. The driving circuit further comprises a first control circuit and a second control circuit that are arranged between a GOA circuit area and an active area (AA area). The first control circuit is configured to control the on/off states of all odd-numbered scanning lines (such as Gate_1 and Gate_3 as shown in FIG. 1) or all even-numbered scanning lines (such as Gate_2 and Gate_4 as shown in FIG. 1) of said scanning lines. The second control circuit is configured to realize different connection states in each pair of scanning lines, which consists of an odd-numbered scanning line and a corresponding even-numbered scanning line (such as Gate_1 and Gate_2, as well as Gate_3 and Gate_4 as shown in FIG. 1) of said plurality of scanning lines under different display modes, said display modes comprising two dimensional display mode and three dimensional display mode, wherein the odd-numbered scanning line and the even-numbered scanning line of a pair of scanning lines are turned on simultaneously under three dimensional display mode.

In the present embodiment, the first control circuit controls the on/off states of all odd-numbered scanning lines. As shown in FIG. 1, the first control circuit comprises a plurality of (a first specified number of) switching transistors (such as TFT_1 and TFT_3 as shown in FIG. 1) and a first control signal line SW1. Each switching transistor is connected to a corresponding odd-numbered scanning line of the plurality of scanning lines. As shown in FIG. 1, the switching transistors TFT_1 and TFT_3 are connected to the odd-numbered scanning lines Gate_1 and Gate_3 respectively. The first control signal line SW1 is configured to control the on/off state of each switching transistor of the first control circuit, and is connected to the gate of each switching transistor of the first control circuit.

The second control circuit comprises a plurality of (a second specified number of) switching transistors (such as TFT_2 and TFT_4 as shown in FIG. 1) and a second control signal line SW2. Each switching transistor is connected between the odd-numbered scanning line and the even-numbered scanning line of a corresponding pair of scanning lines. For example, the switching transistor TFT_2 is connected between the odd-numbered scanning line Gate_1 and the even-numbered scanning line Gate_2 of the first pair of scanning lines, and the switching transistor TFT_4 is connected between the odd-numbered scanning line Gate_3 and the even-numbered scanning line Gate_4 of the second pair of scanning lines. The second control signal line SW2 is configured to control the on/off state of each switching transistor of the second control circuit, and is connected to the gate of each switching transistor of the second control circuit.

The driving procedure when the display panel comprising the above driving circuit performing 2D display and 3D display is interpreted in detail hereinafter.

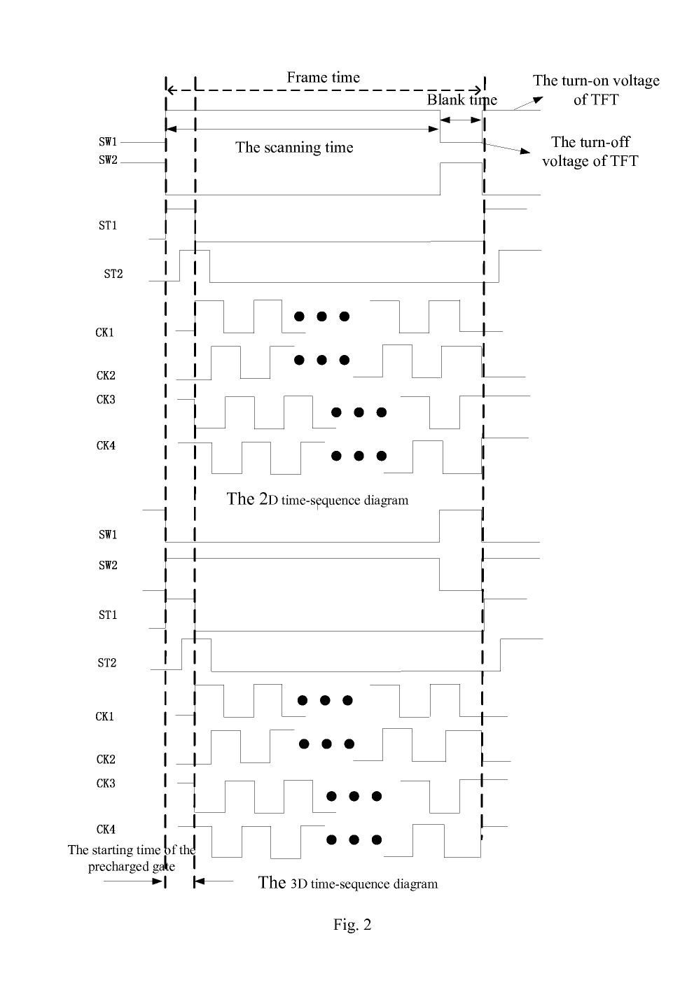

A four-graded precharge scanning mode is adopted in a switching circuit of the GOA circuit area as shown in FIG. 1, and the compatibility of 2D display and 3D display is realized through the aforesaid two control circuits (SW1 and SW2). Reference can be made to FIG. 2, which is a time-sequence diagram when a display panel comprising the driving circuit as shown in FIG. 1 is performing 2D display and 3D display.

During a display stage under two dimensional display mode, the transmission of all odd-numbered scanning lines of the plurality of scanning lines are controlled by the first control circuit, and the connection between the odd-numbered scanning line and the even-numbered scanning line in each pair of scanning lines is turned off by the second control circuit.

Specifically, as shown in the upper view (2D time-sequence diagram) of FIG. 2, in a scanning cycle, the first control signal line SW1 provides a turn-on voltage (the high-level voltage as shown in FIG. 2) to each switching transistor connected thereto, so as to turn on each odd-numbered scanning line. During the same time period, the second control signal line SW2 provides a turn-off voltage (the low-level voltage as shown in FIG. 2) to each switching transistor connected thereto, so as to turn off the connection between the odd-numbered scanning line and the even-numbered scanning line in each pair of scanning lines.

Since the four-graded precharge scanning mode is adopted in the driving circuit of the GOA display panel in this example, the driving circuit comprises four gate driving circuits 31, 32, 33, and 34, which are connected to four scanning lines Gate_1, Gate_2, Gate_3, and Gate_4 respectively, as shown in FIG. 1.

During a scanning cycle, an input end ST1 of the first gate driving circuit 31 receives a first start pulse signal, the duration of which is indicated as gate turning-on time. During this period, clock signals CK1, CK2, CK3, and CK4 are all inactive. During a rise time of the clock signal CK1, the first gate driving circuit 31 outputs a scanning voltage to the scanning line Gate_1 connected thereto, so as to turn on a gate of a switch in the row where the scanning line Gate_1 in the active area is located, and a data driver (not shown in FIG. 1 or FIG. 2) charges the pixels in this row. During a rise time of the clock signal CK3, the scanning line Gate_3 also turns on the gate of this switch to receive source signals from the data driver, and precharges the pixels in the row where the scanning line Gate_3 in the active area is located.

After a set time (which is preferably half of the gate turning-on time) is delayed relative to the first start pulse signal, an input end ST2 of the second gate driving circuit 32 receives a second start pulse signal, the duration of which is indicated as the gate turning-on time. During a rise time of the clock signal CK2, the second gate driving circuit 32 outputs a scanning voltage to the scanning line Gate_2 connected thereto, so as to turn on a gate of a switch in the row where the scanning line Gate_2 in the active area is located, and the data driver charges the pixels in this row. During a rise time of the clock signal CK4, the scanning line Gate_4 also turns on the gate of the switch in the row where the scanning line Gate_4 in the active area is located to receive source signals, and precharges the pixels in the row where the scanning line Gate_4 in the active area is located.

Through the above driving procedures, a progressive scanning of the plurality of scanning lines can be achieved, and thus a normal two dimensional display can be realized.

During a display stage under three dimensional display mode, the transmission of the scanning signals of all odd-numbered scanning lines of the plurality of scanning lines is controlled by the first control circuit; and the odd-numbered scanning line and the even-numbered scanning line in each pair of scanning lines of the plurality of scanning lines are connected with each other by the control of the second control circuit, i.e., the odd-numbered scanning line and the even-numbered scanning line in each pair of scanning lines are connected with each other through short-circuit.

Specifically, as shown in the lower view (3D time-sequence diagram) of FIG. 2, during a scanning cycle, when all odd-numbered scanning lines are turned on, the first control signal line SW1 provides a turn-off voltage to each switching transistor connected thereto, and thus the transmission of scanning signals of all odd-numbered scanning lines is turned off. However, at this moment, the transmission of scanning signals of all even-numbered scanning lines is not turned off. That is to say, when the first control signal line SW1 provides a turn-off voltage to all odd-numbered scanning lines, the even-numbered scanning lines are turned on. At the same time, during this time period, the second control signal line SW2 provides a turn-on voltage to each switching transistor connected thereto, so as to realize short-circuit between the odd-numbered scanning line and the even-numbered scanning line in each pair of scanning lines of the plurality of scanning lines. In this case, the odd-numbered scanning line and the even-numbered scanning line in each pair of scanning lines can be turned on or turned off simultaneously, and thus the dual-gates (dual scanning lines) can be turned on simultaneously.

And then, a progressive scanning of scanning lines can be realized through the precharge scanning mode as in two dimensional display mode, and thus a better 3D display effect can be achieved. It should be noted that, the voltage provided by each control circuit during the blank time is opposite to the voltage provided by the same control circuit during the scanning time, and in this manner, the performance of the switching transistor can be more stable.

Furthermore, through the above driving procedures, during the black frame inserting process in the three dimensional display stage, the dual-gates, which are provided to reduce the influence of high frame rate on the charging of the liquid crystal panel, can be turned on simultaneously. That is to say, all odd-numbered scanning lines or all even-numbered scanning lines can be turned on simultaneously. In this manner, the resolution in the scanning direction can be reduced, the charging time can be improved, and a better 3D display effect can be realized.

It should be noted that, in the present embodiment the first control circuit controlling all odd-numbered scanning lines is illustrated as an example; however, in other embodiments, the purpose of the present disclosure can also be realized in a manner that the first control circuit controls all even-numbered scanning lines, the details of which are no longer repeated here. In addition, although the GOA driving circuit with a four-graded precharge scanning mode is illustrated herein, the GOA driving circuit with other precharge scanning modes can also be used.

In summary, two control circuits are added between a GOA circuit area and an active area of a GOA display panel, wherein one control circuit means adding a TFT control switch to each of all odd-numbered scanning lines or all even-numbered scanning lines, and another control circuit means adding a TFT control switch between an odd-numbered scanning line and a corresponding even-numbered scanning line which together form a pair of scanning lines. By means of the two control circuits, a normal two dimensional display can be realized, and the dual-gates are turned on simultaneously through SG black frame insertion technology during 3D display. In addition, the circuits can be realized only with the two empty pins of the source driving IC, which means no new additional design is necessary. The display effect thereof can be improved, and at the same time, the cost thereof can be reduced.

The preferred embodiments of the present disclosure are stated hereinabove, but the protection scope of the present disclosure is not limited by this. Any changes or substitutes readily conceivable for any one skilled in the art within the technical scope disclosed by the present disclosure shall be covered by the protection scope of the present disclosure. Therefore, the protection scope of the present disclosure shall be determined by the scope as defined in the claims.

1. A driving circuit device for GOA display panel, comprising:
a plurality of scanning lines;
a first control circuit, configured to control the on/off states of all odd-numbered scanning lines or all even-numbered scanning lines of said plurality of scanning lines; and
a second control circuit, configured to realize different connection states in each pair of scanning lines, which consists of an odd-numbered scanning line and a corresponding even-numbered scanning line of said plurality of scanning lines under different display modes, said display modes comprising two dimensional display mode and three dimensional display mode, wherein the odd-numbered scanning line and the even-numbered scanning line of a pair of scanning lines are turned on simultaneously under three dimensional display mode.

2. The driving circuit device according to claim 1, wherein said first control circuit and said second control circuit are both arranged between a GOA circuit area and an active area, and wherein
said first control circuit comprises:
a first specified number of switching transistors, each switching transistor being connected to a corresponding odd-numbered scanning line or a corresponding even-numbered scanning line of said plurality of scanning lines respectively; and
a first control signal line, configured to control the on/off state of each switching transistor, said first control signal line being connected to the gate of each of said first specified number of switching transistors, and
said second control circuit comprises:
a second specified number of switching transistors, each switching transistor being connected between the odd-numbered scanning line and the even-numbered scanning line of a corresponding pair of scanning lines respectively; and
a second control signal line, configured to control the on/off state of each switching transistor, said second control signal line being connected to the gate of each of said second specified number of switching transistors.

3. The driving circuit device according to claim 2, wherein the ends of said first control circuit and said second control circuit are arranged in two empty pins of a source driving chip respectively.

4. A GOA display panel, comprising a driving circuit device, said driving circuit device comprising:
a plurality of scanning lines;
a first control circuit, configured to control the on/off states of all odd-numbered scanning lines or all even-numbered scanning lines of said plurality of scanning lines; and
a second control circuit, configured to realize different connection states in each pair of scanning lines, which consists of an odd-numbered scanning line and a corresponding even-numbered scanning line of said plurality of scanning lines under different display modes, said display modes comprising two dimensional display mode and three dimensional display mode, wherein the odd-numbered scanning line and the even-numbered scanning line of a pair of scanning lines are turned on simultaneously under three dimensional display mode.

5. The GOA display panel according to claim 4, wherein said first control circuit and said second control circuit are both arranged between a GOA circuit area and an active area, and wherein
said first control circuit comprises:
a first specified number of switching transistors, each switching transistor being connected to a corresponding odd-numbered scanning line or a corresponding even-numbered scanning line of said plurality of scanning lines respectively; and
a first control signal line, configured to control the on/off state of each switching transistor, said first control signal line being connected to the gate of each of said first specified number of switching transistors, and
said second control circuit comprises:
a second specified number of switching transistors, each switching transistor being connected between the odd-numbered scanning line and the even-numbered scanning line of a corresponding pair of scanning lines respectively; and
a second control signal line, configured to control the on/off state of each switching transistor, said second control signal line being connected to the gate of each of said second specified number of switching transistors.

6. The GOA display panel according to claim 5, wherein the ends of said first control circuit and said second control circuit are arranged in two empty pins of a source driving chip respectively.

7. A method for driving a GOA liquid crystal display panel, said liquid crystal display panel comprising a plurality of scanning lines, and a first control circuit and a second control circuit both arranged between a GOA circuit area and an active area of said GOA liquid crystal display panel, said method comprising:
during a display stage under different display modes,
controlling, by said first control circuit, the on/off states of all odd-numbered scanning lines or all even-numbered scanning lines of said plurality of scanning lines; and
realizing, by said second control circuit, different connection states in each pair of scanning lines, which consists of an odd-numbered scanning line and a corresponding even-numbered scanning line of said plurality of scanning lines, said display modes comprising two dimensional display mode and three dimensional display mode, wherein the odd-numbered scanning line and the even-numbered scanning line of a pair of scanning lines are turned on simultaneously under three dimensional display mode.

8. The method according to claim 7, further comprising:
during a display stage under two dimensional display mode,
providing, by the first control signal line of said first control circuit, a turn-on voltage to each of the first specified number of switching transistors, so as to turn on all odd-numbered scanning lines or all even-numbered scanning lines, wherein the gate of each of said first specified number of switching transistors is connected to said first control signal line;
providing, by the second control signal line of said second control circuit, a turn-off voltage to each of the second specified number of switching transistors, so as to turn off the connection between the odd-numbered scanning line and the even-numbered scanning line in each pair of scanning lines, wherein the gate of each of said second specified number of switching transistors is connected to said second control signal line; and
controlling a progressive transmission of scanning signals of each scanning line of said plurality of scanning lines with precharge scanning mode.

9. The method according to claim 8, further comprising:
during a display stage under three dimensional display mode,
providing, by said first control signal line, when all odd-numbered scanning lines or all even-numbered scanning lines of said scanning lines are turned on, a turn-off voltage to each of the first specified number of switching transistors, so as to turn off all odd-numbered scanning lines or all even-numbered scanning lines;
providing, by said second control signal line, during the whole scanning cycle, a turn-on voltage to each of the second specified number of switching transistors, so as to realize short-circuit between the odd-numbered scanning line and the even-numbered scanning line in each pair of scanning lines; and
controlling a progressive transmission of scanning signals of each scanning line of said plurality of scanning lines with precharge scanning mode.

10. The method according to claim 8, wherein said precharge scanning mode is four-graded precharge scanning.

11. The method according to claim 9, wherein said precharge scanning mode is four-graded precharge scanning.
